(19) United States
(12) Patent Application Publication
(10) Pub. No.: US 2009/0174191 A1
(43) Pub. Date: Jul. 9, 2009

(54) Head wind ecological driving system

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, JP

(21) Appl. No.: 12/006,924

(22) Filed: Jan. 8, 2008

(51) Int. Cl. F03D 9/00

(52) U.S. Cl. 290/55

(57) ABSTRACT

The invention is related to saving fuels as well as suppressing against emanating CO₂ gas in driving vehicle converting said head wind into driving force to operate said ducted roof fan by means of comprising driving energy booster such as resonance, lift and electricity.

### FIELD OF THE INVENTION

The present invention is related to a technology on saving for fuels and subsequent to CO₂ gas by means of retrieving driving energy exhausted by driving vehicles converting head wind to rotating force to operate a fan or fans enclosed in the duct on the roof of said vehicle to be augmented by resonance caused by head wind with vibration provided to said duct in driving operation. More specially, this invention relates to the use of supplemental driving forces available for further developing power such as lift as well as generator involved.

### DESCRIPTION OF THE RELATED ART

Any discussion of the prior art throughout the specification should in no way be considered as an admission that such prior art is widely known or famous part of common general knowledge in the field.

Ecological driving systems are commonly used throughout many kinds of inside driving power devices such as engines, motors, batteries and hybrid driving power sources. Whereas, driving performances as well as efficiency in the conventional driving technologies involved in such as hybrid cars, electric vehicles and etc. have been suffered from remaining as being insufficient to be required for keeping for global clean air environment from ecological point of view.

### BRIEF SUMMARY OF THE INVENTION

The Head Wind Ecological Driving System of this invention overcomes the problems associated with prior art. An extra power supplying source or additional fuel is not required for operating said system. Nor is additional increase for exhausting gas in order to operate said system. The Head Wind Ecological Driving System comprise main three elements which are resonance, lift and electricity caused by head wind converted from resistance to expediting power for driving force with the function of the ducted roof fan in driving vehicles.

Resonance arising from vibration on said duct provided by said head wind is liable to develop rotating force for said roof fan in magnificent folds with no additional fuels nor other power sources to be supplied. Resonance cause for the same principle as the effect that small wrist power activated in consecutive swing behavior in playing a yo-yo allow to be available for much more powerful performance in keeping impact with longer distance at expansion and contraction by means of coinciding with same frequency without supplying for additional power, thus serving to decrease fuels and subsequent to emanating CO₂ gas in driving vehicles.

Lift produced by the wing which is added with a flap, if necessary, succeeding to the rear end of said roof of said vehicle is capable of providing sufficient lifting force for driving said vehicles in view of lift force involved in a propeller-driven airplane in taking-off, eventually serve to decrease the weight of said vehicles and subsequently saving fuels in driving operation.

Electricity which is generated by the generator fitted at a position of the hub of said roof fan to be co-rotated with blades of said fan to be augmented in rotating work and subsequently being in produced at a large volume by said resonated head wind is connected with said wire to supply with a battery or a condenser or a capacitor successively in operating either motor or electric appliances of said vehicles in driving operation. It is easily understood that generating efficiency of this case is much better than the case with a wind generator due to the fact that consecutive head wind is available for successive generating operation as compared to said wind generator which is necessary for stopping operation as feathering for fear of breaking down the equipment at strong wind.

### BRIEF DESCRIPTION OF THE DRAWINGS

FIG. 1: One example of the cross sectional view of the vehicle applied to this invention

### DETAILED DESCRIPTION OF THE INVENTION

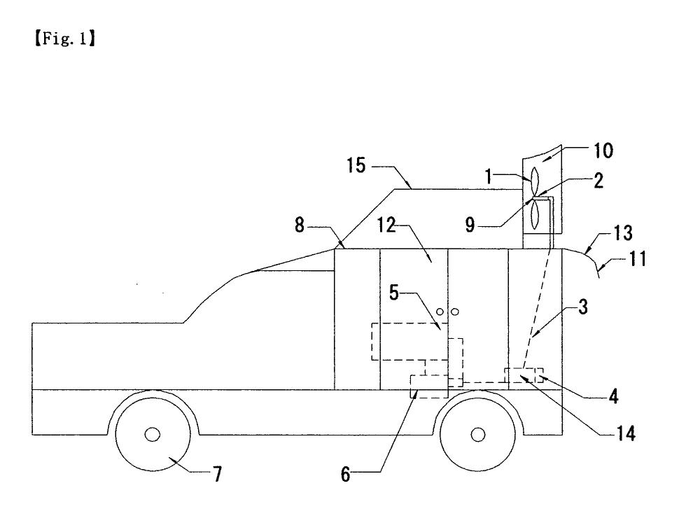

Overview: The main essence of this invention comprise of three elements of function to expedite driving vehicle to be operated by head wind converting from resistant load (not shown in FIG. 1) against driving force into assisting driving force by means of operating a fan(1) enclosed in the duct(10), whereby resonance is caused with synchronous frequency of both vibration on said duct (10) provided by said head wind and that of said head wind, thus serving to amplify the operating force for said ducted(10) roof(8) fan(1) without supplying any other energy resource and so the present invention allow to partially retrieve energy loss in driving operation. The present invention comprise mainly three elements which are resonance, lift and electricity (not shown in FIG. 1) to be activated for saving fuels and entailing CO₂ gas only to be operated by said head wind through driving operation of said vehicles.

Resonance is available for both synchronous frequency of vibration on said duct(10) provided with said head wind and that of said head wind, whereby energy allow to be stored up in vibrating air flow to develop for large rotating force on said fan(1), thus serving to increase driving power of said vehicle sufficiently without being supplied with any other energy, thus saving much fuels in driving operation. This is the same principle as the continuous swinging force to keep a constant length of rope in respective swing in playing a yo-yo game where equal power in repeated operation for expansion and contraction of the rope continuously. As shown in FIG. 1, said fan(1) is rotated by said head wind blowing on the surface of said roof(8) guided with convergent fences(15) to impinge on moving said blades of said fan(1) enclosed in said duct(10) to resonate, whereby rotating force is boosted to expel a large volume of air flow and the propulsive force derived from the reaction allow to provide sufficient driving force for said vehicle not necessary for any supplying any other energy sources, thus enabling to save a large volume of fuels and subsequent to suppress emanating CO₂ gas in driving operation. According to our generating test, the generation of electric power generated by a ducted fan of which blades are rotated by a blower proved approximately 10 times as much as that of a fan without duct with equal output. It is necessary for collecting large volume of wind as much as possible to develop for the high electric power in operating this generating system, converging fences(15) guiding air stream from front towards rear part of roof(8) of said vehicle must be installed on said roof(8) to prevent from being deflected from original pass by the side wind and to secure wide range of said head wind directing to said fan(1) in straight direction.

Lift is provided with the wind deflected on the reverse wall of said wing(13) which is apt to push up to be caused by pressure difference between surface and reverse of said wing(13) succeeding to a flap(11), wherein the propulsive force is deprived from the reaction produced by a stream of said head wind which is expelled after passing through said ducted roof fan(1) to be directed rearwards at high velocity, thus sufficient lift force is available in view of the propeller-driven airplane at taking-off involved, and subsequently serving to reduce the weight of said vehicles and to save fuels and subsequently to suppress emanating CO₂ gas in driving operation of said vehicle. In addition, another lift is available for said vehicle caused by strong wind to push up said reverse wall of said wing(13) in rotating operation of the tire(7) of said vehicle. Thus, said lift is liable to serve decreasing weight of vehicles and eventually reducing loss of fuels entailing emanating CO₂ gas in driving operation.

Electricity is produced by generator(9) fitted around hub(2) to be generated with rotating operation of multi-blades of said fan(1) as the same principle as the wind generator generate, and is transmitted through wire (3) connected to the battery (4) or the motor (6) through either condenser(14) or capacitor(14) equipped therein to drive said vehicle or supplement for the driving force to assist operation of the engine(5) of said vehicle. Whereby, rotating operation of said ducted(10) roof(8) fan(1) is possible successively to provide electricity through wires without wasting other additional fuels and nor required so often for stopping to charge in case of the electric vehicle and the hybrid car. Especially, the hybrid car is allowed to remove the switching device to interchange from motor to engine or adversely due to successive supply for the electricity. Therefore, said generating system which is also secured for high electric driving force without any loss for the additional power, thus allowing to save a large volume of fuels as well as CO₂ gas entailed therewith.

1. Head Wind Ecological Driving System comprise resonance which is available for synchronous frequency of both vibration on the duct provided by head wind and that of said head wind flowing on the surface of the roof along guiding fence installed from front to rear part of said roof of the vehicle preventing from being deflected from original pass by side wing directed to the fan enclosed in said duct to convert from resistance into driving force for said vehicle by means of rotating said ducted roof fan in driving operation, wherein driving force is considerably augmented by resonance, thus serving to save fuels and suppress CO₂ gas in driving vehicle.

2. Head Wind Ecological Driving System comprise lift which is produced by pressure difference between the velocity of the fluid flowing on the surface and under the reverse of the wing succeeded with flap to be expelled from said ducted roof fan in rotating operation to be operated by said head wind, thus serving to reduce the weight of the vehicle to save fuels and suppress CO₂ gas in driving vehicle.

3. Head Wind Ecological Driving System comprise electricity generated with generator fitted to the ducted roof fan to be operated by head wind to be transmitted through wire to either battery or electric appliance such as capacitor and condenser to be used for driving motor, thus serving to save fuels and suppress CO₂ gas in driving vehicle.
